(19) United States
(12) Patent Application Publication
(10) Pub. No.: US 2016/0356954 A1
(43) Pub. Date: Dec. 8, 2016

(54) OPTICAL WAVEGUIDES FOR OPTOELECTRONIC DEVICES AND METHODS OF MAKING THE SAME

(71) Applicant: EMPIRE TECHNOLOGY DEVELOPMENT LLC, Wilmington, DE (US)

(72) Inventor: Hidekazu HAYAMA, Osaka (JP)

(73) Assignee: EMPIRE TECHNOLOGY DEVELOPMENT LLC, Wilmington, DE (US)

(21) Appl. No.: 15/101,757

(22) PCT Filed: Dec. 3, 2013
(86) PCT No.: PCT/US2013/072735

§ 371 Date: Jun. 3, 2016

(51) Int. Cl. G02B 6/122; G02B 6/138; G02B 6/12; G02B 6/132

(52) U.S. Cl. CPC G02B 6/122; G02B 6/1221; G02B 6/132; G02B 6/138; G02B 6/12004; G02B 2006/12095

(57) ABSTRACT

An optical waveguide may include a graded refractive index structure including a core structure, and a cladding at least partially surrounding the core structure and having an outer surface and an inner surface contacting the core structure. The core structure of the optical waveguide may have a higher refractive index than the cladding. The cladding may have a decreasing refractive index from the inner surface toward the outer surface. Optoelectronic devices that includes the optical waveguide, and methods of making the optical waveguide are also provided.

### BACKGROUND

Unless otherwise indicated herein, the materials and approaches described in this section are not prior art to the claims in this application and are not admitted to be prior art by inclusion in this section.

In implementing an optoelectronic system such as an optical communication system, alignment of an optical element (for example, a light-emitting unit, or a light-receiving unit) with another optical element (for example, an optical waveguide) may be required. In such systems, the light-emitting unit such as a semiconductor laser or an LED (light-emitting diode) may serve as a source for generating optical communication signals while the optical waveguide serves as a channel for optical signal propagation. Accordingly, precise alignment of the light-emitting unit with the optical waveguide may be important for providing a high speed and quality communication performance with minimal light propagation loss.

Some methods for alignment of a light-emitting unit with an optical waveguide have been developed for practical use. In some example methods, individual optical elements can be mounted by a machine manipulator at predetermined positions on a substrate which has been machined with high-precision machining process or MEMS (micro-electro-mechanical systems) process. However, due to the limitation of machining precision and mechanical manipulation precision, such example methods may not be applicable to high-precision alignment.

### SUMMARY

Some embodiments disclosed herein may include an optical waveguide including a core structure, and a cladding at least partially surrounding the core structure. The cladding may have an inner surface and an outer surface, and the inner surface of the cladding may contact the core structure. Further, the core structure may have a higher refractive index than the cladding, and the cladding may have a decreasing refractive index from the inner surface toward the outer surface.

In some embodiments, a method of making an optical waveguide may be provided. In example methods, a core ink and a plurality of cladding inks may be deposited on a substrate such that the core ink forms a core structure and the plurality of cladding inks form a cladding at least partially surrounding the core structure. The cladding may have an inner surface and an outer surface, and the inner surface of the cladding contacts the core structure. The core ink may be configured to form the core structure having a higher refractive index than the cladding, and the plurality of cladding inks may be configured to form the cladding having a decreasing refractive index from the inner surface toward the outer surface.

In some embodiments, a method for manufacturing an optoelectronic device may be provided. In example methods, an optical waveguide may be formed by depositing a core ink and a plurality of cladding inks on a substrate such that the core ink forms a core structure and the plurality of cladding inks form a cladding at least partially surrounding the core structure. The cladding may have an inner surface and an outer surface, and the inner surface of the cladding may contact the core structure. Further, the core ink may be configured to form the core structure having a higher refractive index than the cladding, and the plurality of cladding inks may be configured to form the cladding having a decreasing refractive index from the inner surface toward the outer surface.

In some embodiments, an optoelectronic device may be provided. The optoelectronic device may include an optical waveguide including a core structure and a cladding at least partially surrounding the core structure, the cladding having an inner surface and an outer surface, and the inner surface of the cladding contacting the core structure. The core structure may have a higher refractive index than the cladding, and the cladding may have a decreasing refractive index from the inner surface toward the outer surface. The optoelectronic device may further include a substrate having through-holes exposing a first end and a second end of the optical waveguide, a light-emitting unit arranged in proximity to the through-hole at the first end, and a light-receiving unit arranged in proximity to the through-hole at the second end. A portion of the first end of the optical waveguide may include a first angled surface for directing light from the light-emitting unit through the optical waveguide toward the second end. Further, a portion of the second end of the optical waveguide may include a second angled surface for directing light propagating along the second end of the optical waveguide toward the light-receiving unit.

In some embodiments, a method of propagating light using an optoelectronic device may be provided. The optoelectronic device may include an optical waveguide including a core structure and a cladding at least partially surrounding the core structure, the cladding having an inner surface and an outer surface, and the inner surface of the cladding contacting the core structure. The core structure may have a higher refractive index than the cladding, and the cladding may have a decreasing refractive index from the inner surface toward the outer surface. The optoelectronic device may further include a substrate having through-holes exposing a first end and a second end of the optical waveguide, a light-emitting unit arranged in proximity to the through-hole at the first end, and a light-receiving unit arranged in proximity to the through-hole at the second end. A portion of the first end of the optical waveguide may include a first angled surface for directing light from the light-emitting unit through the optical waveguide toward the second end. Further, a portion of the second end of the optical waveguide may include a second angled surface for directing light propagating along the second end of the optical waveguide toward the light-receiving unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically shows a cross-sectional view of an illustrative example optoelectronic device including optical elements which are aligned with an optical waveguide with a graded refractive index, arranged in accordance with at least some embodiments described herein.

FIG. 2A schematically shows a cross-sectional view of an illustrative example light emitting unit which is misaligned with an optical waveguide with a graded refractive index, arranged in accordance with at least some embodiments described herein.

FIG. 2B schematically shows a trajectory of light in an illustrative example light emitting unit which is aligned with an optical waveguide with a graded refractive index, arranged in accordance with at least some embodiments described herein.

FIG. 3 illustrates an example flow diagram of a method adapted to manufacture an optoelectronic device, arranged in accordance with at least some embodiments described herein.

FIG. 4A schematically illustrates formation of an optical waveguide having a graded refractive index on a substrate using an inkjet printing method, arranged in accordance with at least some embodiments described herein.

FIG. 4B schematically shows a cross-sectional view of an illustrative example optical waveguide having a graded refractive index which is formed on a substrate using an inkjet printing method, arranged in accordance with at least some embodiments described herein.

FIG. 4C schematically shows a cross-sectional view of an illustrative example optical waveguide having a graded refractive index formed in a substrate, where a through-hole is formed in the substrate to expose an end of the optical waveguide and a light-emitting unit is positioned in proximity to the through-hole, arranged in accordance with at least some embodiments described herein.

FIG. 4D schematically shows a cross-sectional view of an illustrative example optical waveguide having a graded refractive index formed in a substrate, where a portion of the optical waveguide is removed to form an angled surface for directing light from a light emitting unit through the optical waveguide, arranged in accordance with at least some embodiments described herein.

FIG. 5 illustrates a graph showing relationship between hollow silica nanoparticle content and refractive index in an illustrative example optical waveguide having a graded refractive index, arranged in accordance with at least some embodiments described herein.

FIG. 6 illustrates a graph showing transmission spectrum of an illustrative example optical waveguide containing 60 wt % of hollow silica nanoparticles, arranged in accordance with at least some embodiments described herein.

FIG. 7 illustrates a graph showing relationship between zirconia nanoparticle content and refractive index in an illustrative example optical waveguide having a graded refractive index, arranged in accordance with at least some embodiments described herein.

FIG. 8 illustrates a graph showing transmission spectrum of an illustrative example optical waveguide containing 80 wt % of zirconia nanoparticles, arranged in accordance with at least some embodiments described herein.

FIG. 9 illustrates a graph showing refractive index profile of an illustrative example film for an optical waveguide, arranged in accordance with at least some embodiments described herein.

FIG. 10 shows an illustrative example film with a graded refractive index structure using an inkjet printing method, arranged in accordance with at least some embodiments described herein.

FIG. 11 shows another illustrative example film with a graded refractive index structure using an inkjet printing method, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Technologies are herein generally described for an optical waveguide having a graded refractive index structure.

In some examples, an optical waveguide may include a graded refractive index structure including a core structure, and a cladding at least partially surrounding the core structure and having an outer surface and an inner surface contacting the core structure. The core structure of the optical waveguide may have a higher refractive index than the cladding. Also, the cladding may have a decreasing refractive index from the inner surface toward the outer surface. An optoelectronic device may include the optical waveguide with the graded refractive index structure, one end of which may be substantially aligned with a light-emitting unit. If light is emitted from the light-emitting unit toward the end of the optical waveguide, the light can be effectively confined and collected into the optical waveguide due to the graded refractive index structure.

In some examples, the graded refractive index structure of the optical waveguide may be manufactured using an inkjet printing method. In example methods, the optical waveguide may be formed by depositing a core ink and a plurality of cladding inks on a substrate such that the core ink forms the core structure and the plurality of cladding inks form the cladding at least partially surrounding the core structure. The core ink may be formed by mixing a resin, for example, acrylic, urethane, or a combination thereof, with a solvent, for example, organic solvent, water or a combination thereof. Also, each of the plurality of cladding inks may be formed by mixing the core ink and/or the cladding inks with nanoparticles having different concentrations. The plurality of cladding inks may be arranged around the core ink such that concentration of the nanoparticles in the cladding ink may increase radially outwards from the core ink. The nanoparticles may include tin oxide, alumina, zirconia, titania, or a combination thereof. In some other examples, the nanoparticles may include hollow silica nanoparticles, polytetrafluoroethylene (PTFE) nanoparticles, magnesium fluoride nanoparticles, calcium fluoride nanoparticles, silica nanoparticles or a combination thereof.

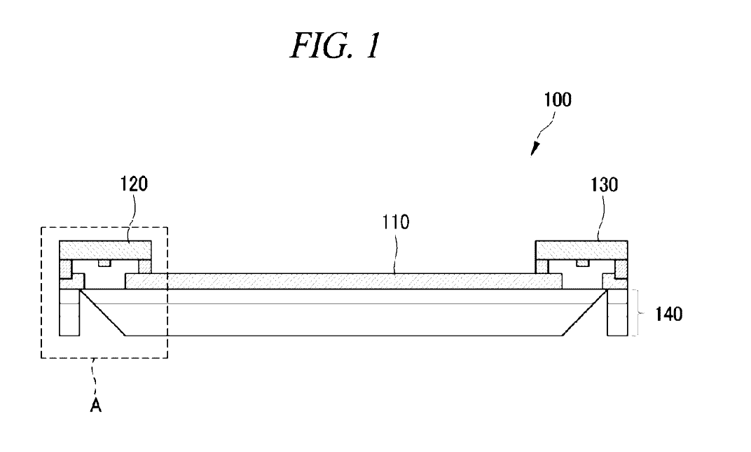

FIG. 1 schematically shows a cross-sectional view of an illustrative example optoelectronic device including optical elements which are aligned with an optical waveguide with a graded refractive index, arranged in accordance with at least some embodiments described herein.

As depicted, an optoelectronic device 100 may include a substrate 110, and a light-emitting unit 120 and a light-receiving unit 130 formed on a first surface of a substrate 110. Optoelectronic device 100 may further include an optical waveguide 140 formed on a second surface of substrate 110 opposing to the first surface. For example, light-emitting unit 120 may include a light-emitting element such as a vertical-cavity surface-emitting laser, an edge-emitting laser, or an LED (light-emitting diode). Also, light-receiving unit 130 may include a light-receiving element such as a photodiode, a phototransistor, or a CCD (charge-coupled device) image sensor.

In some embodiments, optoelectronic device 100 as shown in FIG. 1 may be used as a part of an optical communication system to serve as a unit for transmitting an optical communication signal. For example, light-emitting unit 120 may receive an electrical signal and convert the electrical signal into an optical signal. The optical signal may be then transmitted through optical waveguide 140 and detected by light-receiving unit 130, which may convert the optical signal into an electrical signal.

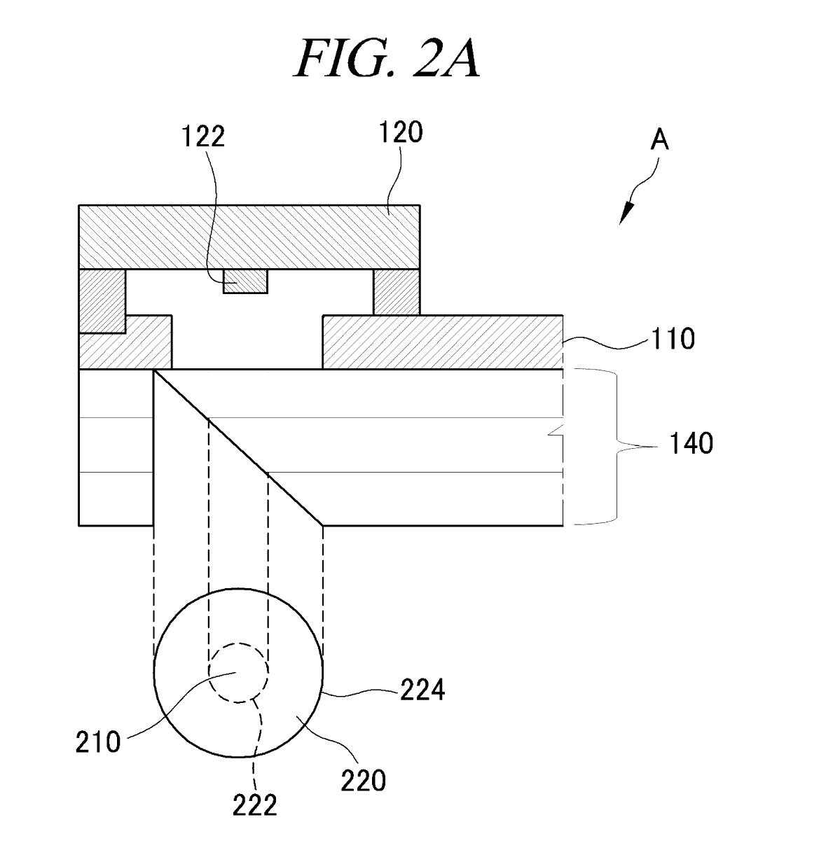

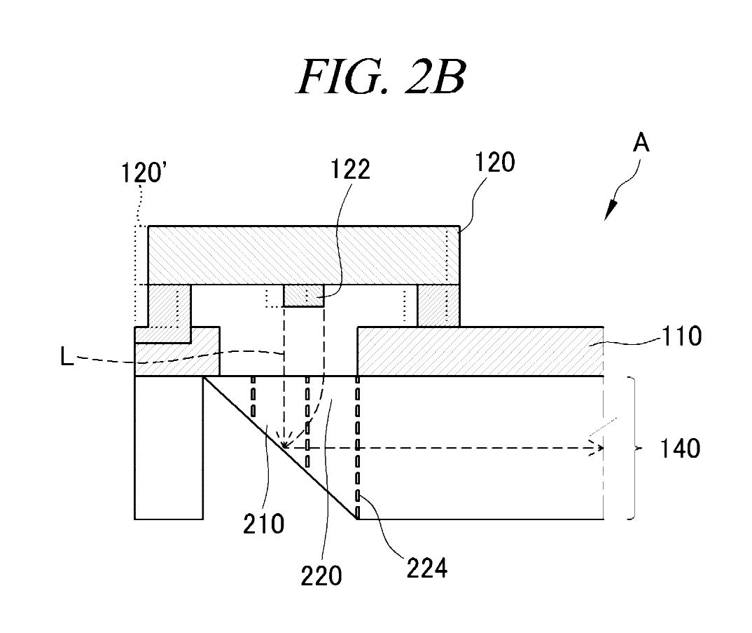

FIG. 2A schematically shows a cross-sectional view of an illustrative example light emitting unit which is aligned with an optical waveguide with a graded refractive index, arranged in accordance with at least some embodiments described herein. In particular, FIG. 2A illustrates a cross-sectional view of a portion A (indicated by a dotted box) of the optoelectronic device 100 shown in FIG. 1.

As depicted, optical waveguide 140 may include a core structure 210 and a cladding 220 at least partially surrounding core structure 210. Cladding 220 may have an inner surface 222 and an outer surface 224, and inner surface 222 of cladding 220 may contact core structure 210. Core structure 210 may have a greater refractive index than cladding 220. Also, cladding 220 may have a decreasing refractive index from inner surface 222 toward outer surface 224. In some embodiments, core structure 210 and cladding 220 may have a decreasing refractive index from a substantial center portion of core structure 210 toward outer surface 224 of cladding 220.

In some embodiments, cladding 220 may have a refractive index of about 1.49 to about 1.52 at inner surface 222 and/or a refractive index of about 1.17 at outer surface 224. Also, core structure 210 may have a refractive index of about 1.49 to about 1.692. Core structure 210 may include acrylic resin, urethane resin, or a combination thereof. Also, cladding 220 may include acrylic resin, urethane resin, or a combination thereof.

In some embodiments, cladding 220 may further include cladding nanoparticles, such as hollow silica nanoparticles, polytetrafluoroethylene (PTFE) nanoparticles, magnesium fluoride nanoparticles, calcium fluoride nanoparticles, silica nanoparticles or a combination thereof, which are disposed in increasing concentrations from inner surface 222 toward outer surface 224. The concentration of the cladding nanoparticles can generally be any concentration, and for example may be about 5% to about 95% by weight at outer surface 224 or at inner surface 222 of cladding 220. For example, the concentration of the cladding nanoparticles may be about 5%, about 15%, about 25%, about 35%, about 45%, about 55%, about 65%, about 75%, about 85%, about 95% by weight, or a concentration between any of these values. Also, the cladding nanoparticles may generally have any average diameter, such as an average diameter of about 5 nm to about 100 nm. For example, the cladding nanoparticles may have an average diameter of about 5 nm, about 10 nm, about 20 nm, about 30 nm, about 40 nm, about 50 nm, about 60 nm, about 70 nm, about 80 nm, about 90 nm, about 100 nm, or an average diameter between any of these values.

In some embodiments, core structure 210 may include a core resin and core nanoparticles dispersed within the core resin. Also, cladding 220 may include a cladding resin, and cladding nanoparticles dispersed within the cladding resin, where cladding 220 may have varying concentrations of the nanoparticles from inner 222 surface to outer surface 224.

In some embodiments, the core resin and the cladding resin may include acrylic, urethane, or a combination thereof. Also, the core nanoparticles and the cladding nanoparticles may include tin oxide, alumina, zirconia, titania, or a combination thereof. The core nanoparticles in core structure 210 may be the same or different from the cladding nanoparticles in cladding 220.

In some embodiments, the core nanoparticles may be present in the core resin in generally any amount, such as an amount of about 5% to about 70% by weight in core structure 210. For example, the core nanoparticles may be present in the core resin in an amount of about 5%, about 10%, about 20%, about 30%, about 40%, about 50%, about 60%, about 70% by weight, or an amount between any of these values. The core nanoparticles may generally have any average diameter, such as an average diameter of about 5 nm to about 100 nm. For example, the core nanoparticles may have an average diameter of about 5 nm, about 10 nm, about 20 nm, about 30 nm, about 40 nm, about 50 nm, about 60 nm, about 70 nm, about 80 nm, about 90 nm, about 100 nm, or an average diameter between any of these values. Also, the cladding nanoparticles may be present in the cladding resin in a decreasing concentration from inner surface 222 to outer surface 224 in cladding 220. In some embodiments, the cladding nanoparticles may be present in the resin in generally any amount, such as an amount of about 5% to about 95% by weight at inner surface 222 or at outer surface 224 of cladding 220. For example, the cladding nanoparticles may be present in the resin in an amount of about 5%, about 10%, about 20%, about 30%, about 40%, about 50%, about 60%, about 70%, about 80%, about 90%, about 95% by weight, or an amount between any of these values. The cladding nanoparticles may generally have any average diameter, such as an average diameter of about 5 nm to about 100 nm. For example, the cladding nanoparticles may have an average diameter of about 5 nm, about 10 nm, about 20 nm, about 30 nm, about 40 nm, about 50 nm, about 60 nm, about 70 nm, about 80 nm, about 90 nm, about 100 nm, or an average diameter between any of these values.

According to the above embodiments, optical waveguide 140 may have a graded refractive index structure, in which the refractive index decreases radially over at least a portion extending from a substantially center of core structure 220 toward outer surface 224 of cladding 220. Accordingly, when light is emitted from light-emitting unit 120 toward optical waveguide 140, the light can be effectively confined and collected into a substantially center of core structure 220.

FIG. 2B schematically shows a trajectory of light in an illustrative example light emitting unit which is misaligned with an optical waveguide with a graded refractive index, arranged in accordance with at least some embodiments described herein. As shown in FIG. 2B, light-emitting device 120 may not be accurately aligned with optical waveguide 140 at a designated position (as outlined by a dotted line 120′). In such case, light L emitted from a light-emitting portion 122 may be effectively confined and collected toward a substantial center of core structure 210 because optical waveguide 140 has a graded refractive index which decreases from the center of core structure 210 toward outer surface 224 of cladding 220.

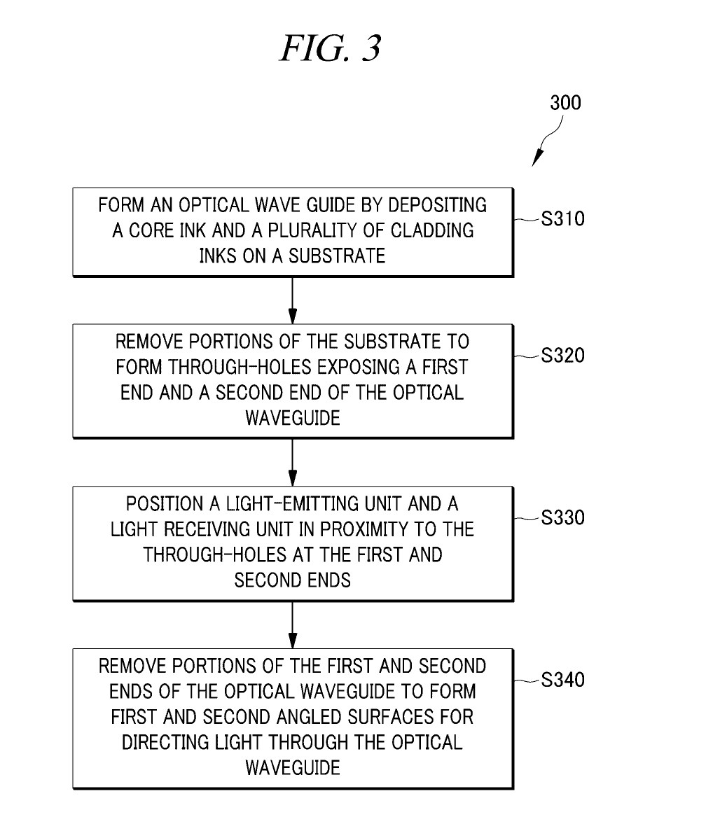

FIG. 3 illustrates an example flow diagram of a method adapted to manufacture an optoelectronic device, arranged in accordance with at least some embodiments described herein.

An example method 300 may include one or more operations, actions, or functions as illustrated by one or more blocks S310, S320, S330 and/or S340. Although illustrated as discrete blocks, various blocks may be divided into additional blocks, combined into fewer blocks, or eliminated, depending on the desired implementation.

At block S310, an optical waveguide may be formed by depositing a core ink and a plurality of cladding inks on a substrate. In this manner, the core ink may form a core structure, such as core structure 210, and the plurality of cladding inks may form a cladding, such as cladding 220, at least partially surrounding the core structure. The cladding may have an inner surface and an outer surface, and the inner surface of the cladding may contact the core structure, in which the core ink may be configured to form the core structure having a higher refractive index than the cladding, and the plurality of cladding inks may be configured to form the cladding having a decreasing refractive index from the inner surface toward the outer surface.

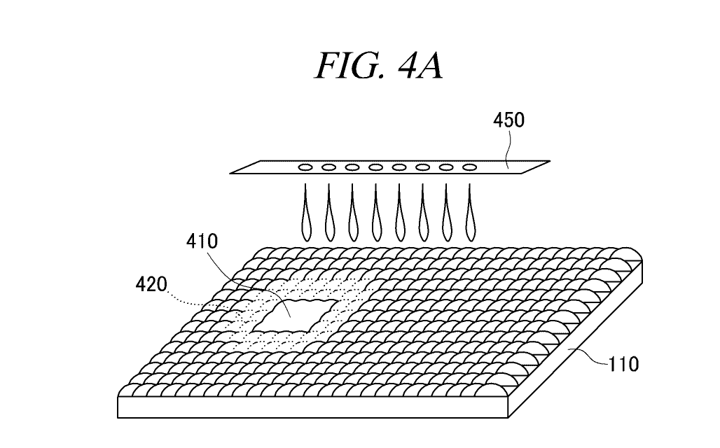

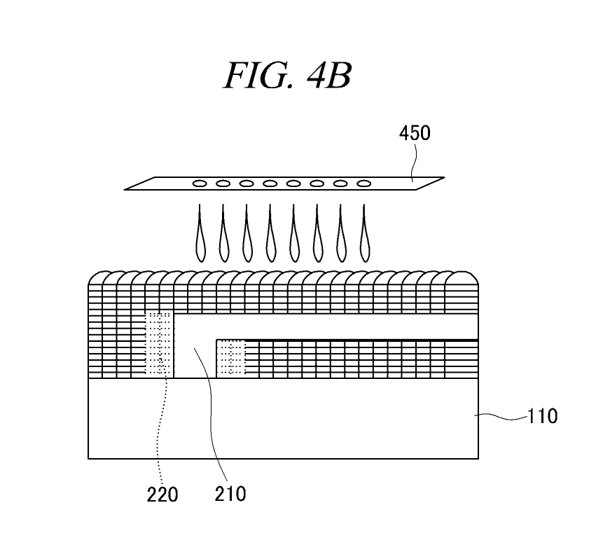

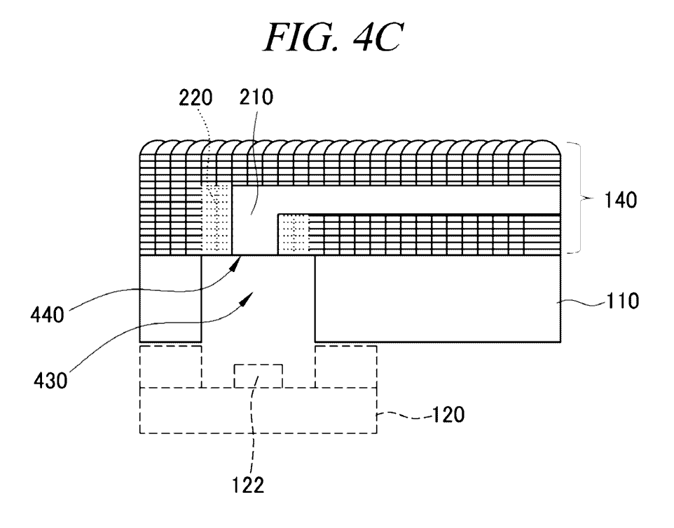

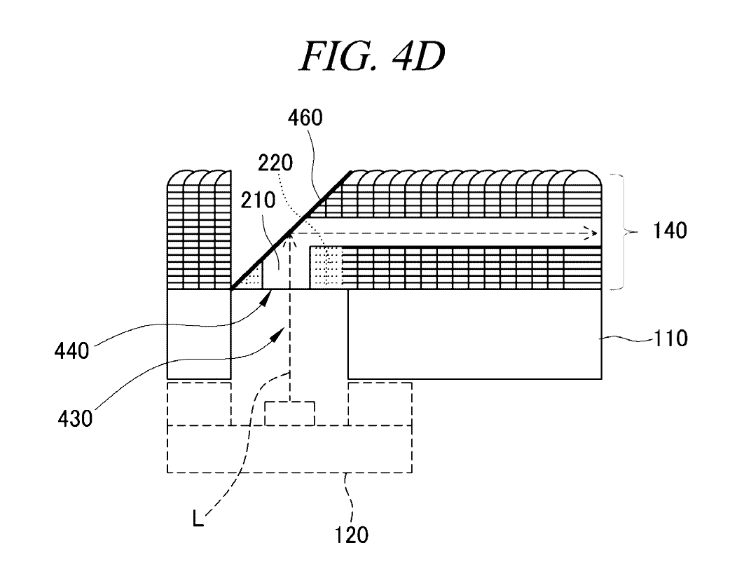

In some embodiments, deposition of the core structure and the cladding may be performed using an inkjet printing method. FIG. 4A schematically illustrates formation of an optical waveguide having a graded refractive index on a substrate using an inkjet printing method, arranged in accordance with at least some embodiments described herein. As depicted, core inks and cladding inks containing transparent materials may be injected from inkjet nozzles 450 onto a substrate 110, e.g. made of silicon, to form a core structure layer 410 having a higher refractive index and a cladding layer 420 having a lower refractive index.

In some embodiments, the core ink (for example, resin emulsion) may be formed by mixing a resin with a solvent, such as organic solvent, water or a combination thereof. The solvent may include water and organic solvent in a weight ratio of about 80:20 to about 20:80. For example, the weight ratio of water to organic solvent may be about 80:20, about 70:30, about 60:40, about 50:50, about 40:60, about 30:70, about 20:80, or a weight ratio between any of these ratios. The resin may include acrylic, urethane, or a combination thereof, which may be present in the form of an emulsion of core shell particles. Each of the core shell particles may have generally any average diameter, such as an average diameter of about 20 nm to about 500 nm and may include acrylic as a core and urethane as a shell surrounding the core. The core shell particles, may for example, have an average diameter of about 20 nm, about 50 nm, about 100 nm, about 150 nm, about 200 nm, about 250 nm, about 300 nm, about 350 nm, about 400 nm, about 450 nm, about 500 nm, or an average diameter between any of these values.

In some embodiments, each of the plurality of cladding inks may be formed by mixing nanoparticles with the core ink, and the plurality of cladding inks may have different concentrations of the nanoparticles. For example, the plurality of cladding inks may be arranged around the core ink such that concentration of the nanoparticles in the cladding ink decreases radially outwards from the core ink. An average diameter of the nanoparticles may generally be any average diameter, such as about 5 nm to about 100 nm. For example, the average diameter of the nanoparticles may be about 5 nm, about 10 nm, about 20 nm, about 30 nm, about 40 nm, about 50 nm, about 60 nm, about 70 nm, about 80 nm, about 90 nm, about 100 nm, or an average diameter between any of these values. The nanoparticles may be present in the core ink in generally any amount, such as an amount of about 0.4% to about 2.2% by weight. For example, the nanoparticles may be present in the core ink in an amount of about 0.4%, about 0.6%, about 0.8%, about 1.0%, about 1.2%, about 1.4%, about 1.6%, about 1.8%, about 2.0%, about 2.2% by weight, or an amount between any of these values. Also, the nanoparticles may be present in the core structure in generally any amount, such as an amount of about 0% to about 50% by weight when the core ink is dried. For example, the nanoparticles may be present in the core ink in an amount of about 0.4%, about 0.6%, about 0.8%, about 1.0%, about 1.2%, about 1.4%, about 1.6%, about 1.8%, about 2.0%, about 2.2% by weight when the core ink is dried, or an amount between any of these values. The nanoparticles may be present in the cladding ink proximal to the core ink in generally any amount, such as an amount of about 5% to about 95% by weight. For example, the nanoparticles may be present in the cladding ink proximal to the core ink in an amount of about 5%, about 10%, about 20%, about 30%, about 40%, about 50%, about 60%, about 70%, about 80%, about 90%, about 95%, or an amount between any of these values. The nanoparticles may be present in the inner surface of the cladding structure in generally any amount, such as an amount of about 5% to about 95% by weight when the cladding ink proximal to the core ink is dried. For example, the nanoparticles may be present in the inner surface of the cladding structure in an amount of about 5%, about 10%, about 20%, about 30%, about 40%, about 50%, about 60%, about 70%, about 80%, about 90%, about 95% by weight when the cladding ink proximal to the core ink is dried, or an amount between any of these values. The nanoparticles may be present in the cladding ink distal to the core ink in generally any amount, such as an amount of about 5% to about 95% by weight. For example, the nanoparticles may be present in the cladding ink distal to the core ink in an amount of about 5%, about 10%, about 20%, about 30%, about 40%, about 50%, about 60%, about 70%, about 80%, about 90%, about 95% by weight, or an amount between any of these values. The nanoparticles may be present in the outer surface of the cladding structure in generally any amount, such as an amount of about 5% to about 95% by weight when the cladding ink distal to the core ink is dried. For example, the nanoparticles may be present in the outer surface of the cladding structure in an amount of about 5%, about 10%, about 20%, about 30%, about 40%, about 50%, about 60%, about 70%, about 80%, about 90%, about 95% by weight when the cladding ink distal to the core ink is dried, or an amount between any of these values.

In some examples, the nanoparticles may include tin oxide, alumina, zirconia, titania, or a combination thereof. In some other examples, the nanoparticles may include hollow silica nanoparticles, polytetrafluoroethylene (PTFE) nanoparticles, magnesium fluoride nanoparticles, calcium fluoride nanoparticles, silica nanoparticles or a combination thereof.

In some embodiments, the organic solvent may include methyl isobutyl ketone, diacetone alcohol, cyclohexanone, 3,5,5-trimethyl-2-cyclohexene-1-one, propyleneglycol monomethyl ether, ethylene glycol monoethyl ether, ethylene glycol monobutyl ether, diethylene glycol monoethyl ether, diethylene glycol monobutyl ether, propyleneglycol monomethylether acetate, ethylene glycol monoethyl ether acetate, ethylene glycol monobutyl acetate, diethyleneglycol monoetyl ether acetate, 1,3-butanediol, 1,4-butanediol, 1,5-pentanediol, 2-methyl-1,3-propanediol, tetraethylene glycol, tetraethylene glycol dimethyl ether, n-methyl-2-pyrrolidone, or a combination thereof.

FIG. 4B schematically shows a cross-sectional view of an illustrative example optical waveguide having a graded refractive index which is formed on a substrate using an inkjet printing method, arranged in accordance with at least some embodiments described herein. As shown in FIG. 4B, multiple layers each including core structure layer 410 and cladding layer 420 as show in FIG. 4A may be repeatedly formed by means of an inkjet printing method until the layers have a predetermined thickness (for example, about 50 to about 250 micro-meters). In this manner, core structure 210 and cladding 220 may be formed to have a graded refractive index structure.

Referring back to FIG. 3, at block S320, a portion of the substrate may be removed to form a through-hole exposing a first end of an optical waveguide. Further, another portion of the substrate may be removed to form a through-hole exposing a second end of an optical waveguide.

FIG. 4C schematically shows a cross-sectional view of an illustrative example optical waveguide having a graded refractive index formed in a substrate, where a through-hole is formed in the substrate to expose an end of the optical waveguide and a light-emitting unit is positioned in proximity to the through-hole, arranged in accordance with at least some embodiments described herein. As depicted, a through-hole 430 may be formed by removing a corresponding portion of substrate 110, such that an end 440 of an optical waveguide 140 may be exposed.

At block S330, a light-emitting unit and a light-receiving unit may be positioned in proximity to the through-hole at the first and second ends of the optical waveguide, respectively. As shown in FIG. 4C, light-emitting unit 120 may be bonded onto substrate 110 so that light emitting portion 122 can be substantially aligned with core structure 220 of optical waveguide 140.

At block S340, a portion of the first end of the optical waveguide may be removed to form a first angled surface for directing light from the light-emitting unit through the optical waveguide toward the second end. Further, a portion of the second end of the optical waveguide may be removed to form a second angled surface for directing light from the first end through the optical waveguide toward the light-receiving unit.

FIG. 4D schematically shows a cross-sectional view of an illustrative example optical waveguide having a graded refractive index formed in a substrate, where a portion of the optical waveguide is removed to form an angled surface for directing light from a light emitting unit through the optical waveguide, arranged in accordance with at least some embodiments described herein. As depicted, a portion of end 440 of optical waveguide 140 may be removed to form a first angled surface 460 for directing light L from light-emitting unit 120 through optical waveguide 140 toward the second end (not shown).

One skilled in the art will appreciate that, this and other processes and methods disclosed herein may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, prior to block S310, a step in which the core ink may be formed by mixing a resin (for example, acrylic, urethane, or a combination thereof) with a solvent (for example, organic solvent, water or a combination thereof) and the plurality of cladding inks may be formed by mixing nanoparticles (for example, nanoparticles containing tin oxide, alumina, zirconia, titania, or a combination thereof, hollow silica nanoparticles, polytetrafluoroethylene (PTFE) nanoparticles, magnesium fluoride nanoparticles, calcium fluoride nanoparticles, silica nanoparticles or a combination thereof) with the core ink may be added.

### EXAMPLES

The present disclosure will be understood more readily by reference to the following examples, which are provided by way of illustration and are not intended to be limiting in any way.

### Example 1

### Fabrication of Core Inks and Cladding Inks

Acrylic resin was used as a transparent material for manufacturing an optical waveguide (for example, optical waveguide 140). The acrylic resin was able to form a gradient composition with refractive index in a range of about 1.49 to about 1.52. In order to enhance adhesion with a substrate (for example, substrate 110), the acrylic resin was mixed with urethane resin. The acrylic resin and the urethane resin were present in the form of an emulsion of core-shell particles, each of which may include acrylic as a core and urethane as a shell surrounding the core. The core-shell particles had an average diameter of about 100 nm.

The emulsion of core-shell particles was used to form the core ink and the plurality of cladding inks. The emulsion had a solid content of 32 wt % were used.

The emulsion was mixed with a water-based solvent having a high boiling point.

The following solvents were used for forming the inks and testing the quality of the inks. An individual solvent was prepared by mixing water and each of the following organic solvents: N-methyl-2-pyrrolidone (having a boiling point of about 202 Celsius degrees), 2-methyl-1,3-propanediol (having a boiling point of about 214 Celsius degrees), diethylene glycol monobutyl ether (having a boiling point of about 231 Celsius degrees), 1,5-pentanediol (having a boiling point of about 239 Celsius degrees), tetraethylene glycol dimethyl ether (having a boiling point of about 275 Celsius degrees), and tetraethylene glycol (having a boiling point of about 328 Celsius degrees). For each solvent, three samples were prepared by mixing the water and the solvent in a weight ratio of 80:20, 60:40, and 20:80. By using each of the above solvent/water samples, the emulsion was diluted such that the solid content was about 10 wt %, to form a sample of ink. A film was then formed by injecting the ink on a substrate. Different films were formed for each of the diluted emulsions with different solvents and different weight ratios of water to solvent.

It was observed that a substantially transparent film was obtained with the ink containing tetraethylene glycol dimethyl ether and tetraethylene glycol, whereas clouding occurred in the films with the ink containing N-methyl-2-pyrrolidone, 2-methyl-1,3-propanediol, diethylene glycol monobutyl ether, and 1,5-pentanediol. The film obtained with the ink containing tetraethylene glycol exhibited the highest transparency. The ink containing tetraethylene glycol also formed substantially transparent films for each of the three samples with different water to tetraethylene glycol weight ratios.

The refractive index of the film formed from the ink containing tetraethylene glycol (water to solvent ratio 80:20) was measured to be about 1.490.

In order to further decrease the refractive index of the film, hollow silica nanoparticles was mixed with the ink. The hollow silica nanoparticles and the emulsion were mixed to form different mixtures having the ratio of the hollow silica nanoparticles to the solid content of the emulsion of about 0:100, about 40:60, about 50:50, about 60:40, about 70:30, about 80:20, about 90:10, and about 100:0. Each of these mixtures was diluted by using a water-based solvent in which the weight ratio of water to tetraethylene glycol was about 80:20 such that the total solid content became 10 wt %. A film was formed by injecting each of the generated inks on a substrate.

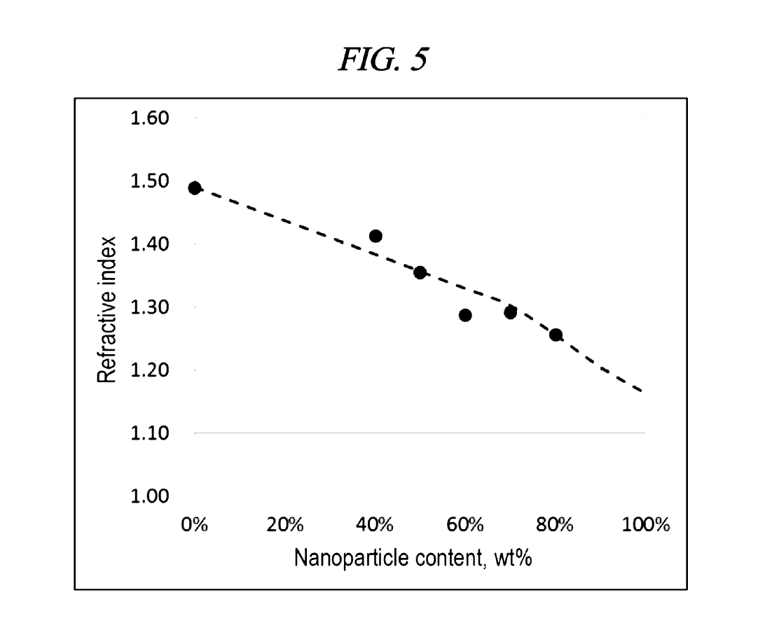

FIG. 5 illustrates a graph showing relationship between hollow silica nanoparticle content and refractive index of the different films formed. As shown in FIG. 5, the refractive index of the films ranged from about 1.17 to about 1.49 as the concentrations of the nanoparticles change from about 100 wt % to about 0 wt %.

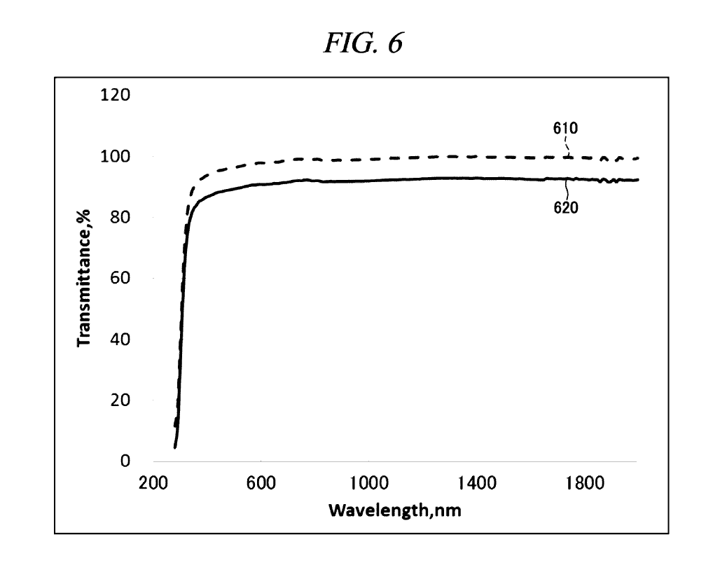

FIG. 6 illustrates a graph showing transmission spectrum of the film containing 60 wt % of hollow silica nanoparticles. In FIG. 6, a curve 620 indicates measured transparency of the film containing 60 wt % of hollow silica nanoparticles while a curve 610 indicates virtual transparency of the film assuming that no reflection loss is present on the top and bottom surfaces of the film. As depicted, the film exhibited about 100% transparency for light having wavelength of greater than about 600 nm.

In light of the above examples, the transparent material formed with hollow silica nanoparticles having the concentration of about 60 wt % (which exhibited a refractive index of about 1.287) was selected to be used for forming the cladding structure having a low refractive index. In order to prepare a transparent material having a high refractive index for the core, nanoparticles having a high refractive index may be introduced into the prepared cladding ink to increase the refractive index.

The nanoparticles having a high refractive index were zirconia. A liquid containing dispersed zirconia nanoparticles was mixed with the emulsion to form different mixtures having the ratio of the zirconia nanoparticles to the solid content of the emulsion of about 0:100, about 40:60, about 50:50, about 60:40, about 70:30, about 80:20, about 90:10, and about 100:0. Each of these mixtures was diluted by using a water-based solvent in which the weight ratio of water to tetraethylene glycol was about 80:20 to yield a total solid content of 10 wt %, thereby preparing the ink. Different films were formed by injecting the inks on a substrate. The formed films exhibited substantial transparency for all of the above mixtures.

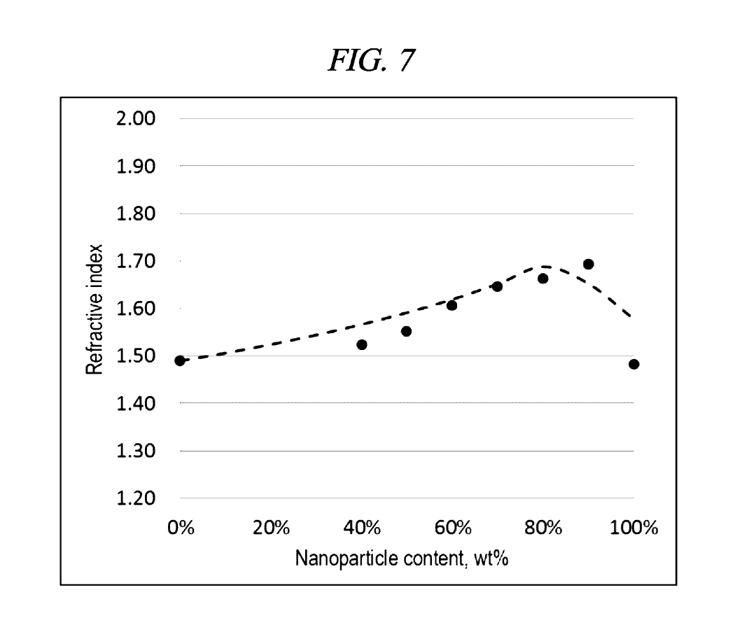

FIG. 7 illustrates a graph showing relationship between zirconia nanoparticle content and refractive index of the formed films. As shown in FIG. 7, the refractive index of the films ranged from about 1.49 to about 1.692 as the concentrations of the nanoparticles change from about 0 wt % to about 100 wt %.

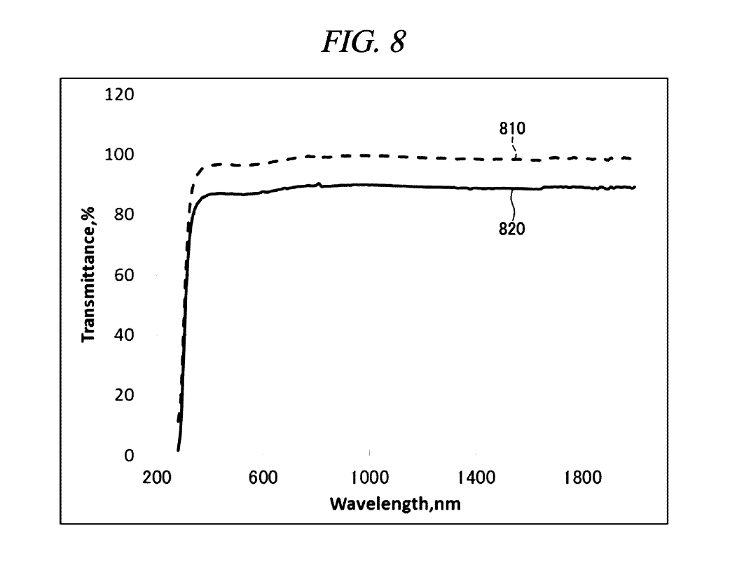

FIG. 8 illustrates a graph showing transmission spectrum of the film containing 80 wt % of zirconia nanoparticles. In FIG. 8, a curve 820 indicates measured transparency of the film containing 80 wt % of zirconia nanoparticles while a curve 810 indicates virtual transparency of the film assuming that no reflection loss is present on the top and bottom surfaces of the film. As depicted, the film exhibited about 100% transparency for light having wavelength of greater than about 600 nm.

In light of the above examples, the transparent material formed with zirconia nanoparticles having the concentration of about 80 wt % (which exhibited a refractive index of about 1.692) was selected to be used for forming the core having a high refractive index.

### Example 2

### Fabrication of Optical Waveguide by Inkjet Printing Method

The refractive index of a lens having a graded refractive-index structure can be varied parabolically as a function of the radius, as shown in the following equation:

$${n}_{r} = {n}_{0} [ 1 - \frac{A}{2} {r}^{2} ]$$

where n₀ is a refractive index at an optical axis of the lens, nᵣ is a refractive index at distance r from the optical axis, and A is a positive constant.

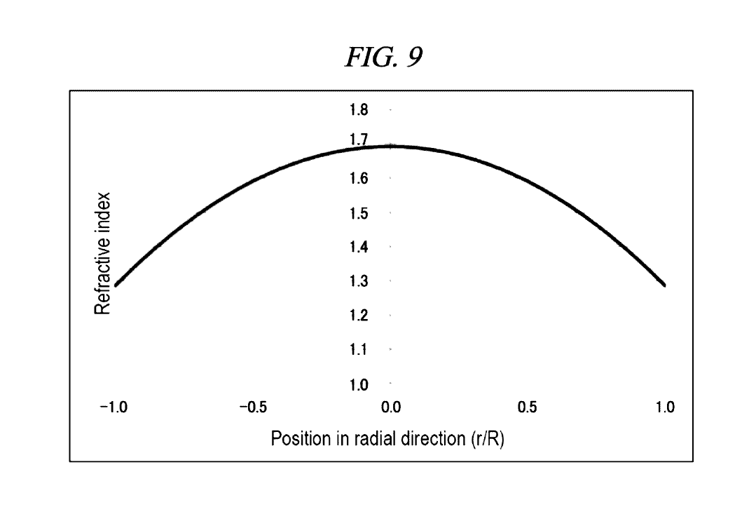

FIG. 9 illustrates a graph showing refractive index profile of an illustrative example film for an optical waveguide, arranged in accordance with at least some embodiments described herein. If it is assumed that an optical waveguide has a cross-section having a radius of denoted by R, a refractive index n₀=1.692 at the optical axis, a refractive index n_{R}=1.287 at the distance R from the optical axis, and A=0.479, the refractive index profile of the optical waveguide may be determined as shown in FIG. 9. The following example describes forming a film with the above-described refractive index profile.

In order to form a film including a core structure and a cladding, an ink with a solid content of 10 wt % was injected dropwise with a droplet volume of 10 picoliter (pl) onto a substrate by an inkjet printing method. As a result, a dot-shaped film with a diameter of about 40 μm and a thickness of about 0.8 μm was obtained per droplet.

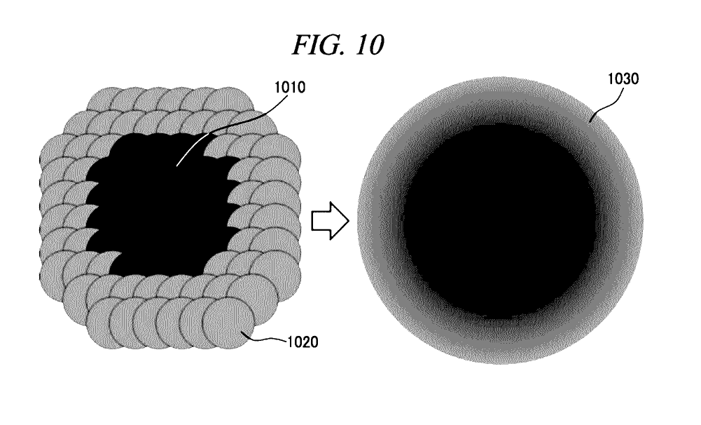

FIG. 10 shows an illustrative example film with a graded refractive index structure formed using an inkjet printing method in accordance with at least some embodiments described herein. Using the inkjet printing method, a similar graded refractive index structure was formed having a pattern with a diameter of about 200 μm, and the pattern was formed from dots having a droplet diameter of about 40 μm each at a resolution of 2560 dpi. The pattern included dots of an ink material having a high refractive index (from Example 1, refractive index=1.692) in a center portion 1010, and dots of an ink material having a low-refractive index ink material (from Example 1, refractive index=1.287) in a peripheral portion 1020. The two ink materials were mixed before the ink droplets were dried such that the refractive index of the dried ink mixture decreases from the core toward the outer portions of the cladding. In this manner, a film 1030 was formed, and the film had a graded refractive index.

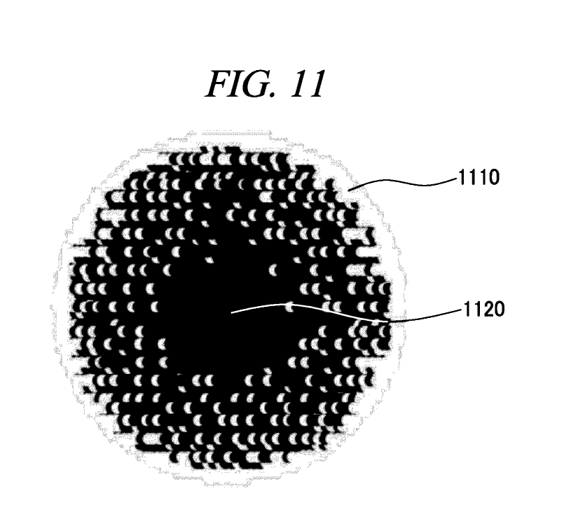

Alternatively, dots were formed on a substrate at a higher resolution by applying ink materials having a refractive index gradually increasing from the center portion toward the peripheral portion. FIG. 11 shows another illustrative example film with a graded refractive index structure formed using an inkjet printing method in accordance with at least some embodiments described herein. A similar graded refractive index structure was formed by applying droplets of inks with different refractive indices at a high resolution, such that the refractive index of the formed film gradually increased from a center portion 1110 toward a peripheral portion 1120.

The above-described ink jet printing method was used to form an optical waveguide having the described graded refractive index structures, as will be described in further detail with reference to FIGS. 4A to 4D. Referring to FIG. 4A, core inks and cladding inks containing transparent materials were injected from inkjet nozzles 450 onto a substrate 110 to form a core structure layer 410 (corresponding to center portion 1010 or 1110 in FIGS. 10 and 11) having a higher refractive index and a cladding layer 420 (corresponding to peripheral portion 1020 or 1120 in FIGS. 10 and 11) having a lower refractive index. The substrate 110 was a silicon substrate. Further, as shown in FIG. 4B, multiple layers each including core structure layer 410 and cladding layer 420 may be repeatedly formed by means of an inkjet printing method until the layers have a predetermined thickness (100 micro-meters). In this manner, core structure 210 and cladding 220 were formed and the resulting waveguides had graded refractive index structures.

Further, as shown in FIG. 4C, through-hole 430 was formed by removing a corresponding portion of substrate 110, such that an end 440 of an optical waveguide 140 was exposed. Light-emitting unit 120 was bonded onto the substrate 110 so that the light emitting portion 122 can be substantially aligned with core structure 220 of optical waveguide 140. Also, as depicted in FIG. 4D, a portion of end 440 of optical waveguide 140 was removed to form a first angled surface 460 for directing light L from the light-emitting unit 120 through the optical waveguide 140 toward a second end (not shown).

According to the above example, optical waveguides having a graded refractive index structure can be formed, in which the refractive index decreases radially over at least a portion extending from the core structure 220 toward an outer surface of cladding 220. Accordingly, when light is emitted from the light-emitting unit 120 toward the optical waveguide 140, the light will be expected to be effectively confined and collected into a substantially center of the core structure 220.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, devices, storage mediums or systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An optical waveguide comprising:
a core structure; and
a cladding at least partially surrounding the core structure, the cladding having an inner surface and an outer surface, and the inner surface of the cladding contacting the core structure,
wherein the core structure has a higher refractive index than the cladding, and
wherein the cladding has a decreasing refractive index from the inner surface toward the outer surface.

2. The optical waveguide of claim 1, wherein the cladding has a refractive index of about 1.49 to about 1.52 at the inner surface.

3. The optical waveguide of claim 1, wherein the cladding has a refractive index of about 1.17 at the outer surface.

4. The optical waveguide of claim 1, wherein the core structure has a refractive index of about 1.49 to about 1.692.

5. The optical waveguide of claim 1, wherein one or more of the core structure and the cladding comprises acrylic resin, urethane resin, or a combination thereof.

6. (canceled)

7. The optical waveguide of claim 1, wherein the cladding comprises hollow silica nanoparticles, polytetrafluoroethylene (PTFE) nanoparticles, magnesium fluoride nanoparticles, calcium fluoride nanoparticles, silica nanoparticles or a combination thereof disposed in increasing concentrations from the inner surface to the outer surface.

8.-10. (canceled)

11. The optical waveguide of claim 1, wherein the core structure comprises:
a core resin; and
core nanoparticles dispersed within the core resin.

12. The optical waveguide of claim 11, wherein the cladding comprises:
a cladding resin; and
cladding nanoparticles dispersed within the cladding resin,
wherein the cladding has varying concentrations of the nanoparticles from the inner surface to the outer surface.

13.-14. (canceled)

15. The optical waveguide of claim 11, wherein the core nanoparticles comprise tin oxide, alumina, zirconia, titania, or a combination thereof.

16. The optical waveguide of claim 12, wherein the cladding nanoparticles comprise tin oxide, alumina, zirconia, titania, or a combination thereof.

17.-18. (canceled)

19. The optical waveguide of claim 11, wherein the core nanoparticles are present in the core resin in an amount of about 5% to about 70% by weight in the core structure.

20. (canceled)

21. The optical waveguide of claim 12, wherein the cladding nanoparticles are present in the resin in an amount of about 5% to about 95% by weight at the inner surface of the cladding and in an amount of about 5% to about 95% by weight at the outer surface of the cladding.

22.-24. (canceled)

25. A method of making an optical waveguide, the method comprising:
depositing a core ink and a plurality of cladding inks on a substrate such that the core ink forms a core structure and the plurality of cladding inks form a cladding at least partially surrounding the core structure, the cladding having an inner surface and an outer surface, and the inner surface of the cladding contacting the core structure;
wherein the core ink is configured to form the core structure having a higher refractive index than the cladding; and
wherein the plurality of cladding inks are configured to form the cladding having a decreasing refractive index from the inner surface toward the outer surface.

26. The method of claim 25, wherein the depositing comprises depositing by inkjet printing.

27. The method of claim 25, wherein the depositing comprises depositing on a silicon substrate.

28. The method of claim 25, further comprising:
forming the core ink by mixing a resin with a solvent; and
forming each of the plurality of cladding inks by mixing nanoparticles with the core ink, wherein the plurality of cladding inks have different concentrations of the nanoparticles.

29. The method of claim 28, wherein mixing comprises mixing acrylic, urethane, or a combination thereof.

30.-34. (canceled)

35. The method of claim 28, wherein depositing comprises arranging the plurality of cladding inks around the core ink such that concentration of the nanoparticles in the plurality of cladding inks increases radially outwards from the core ink.

36. The method of claim 28, wherein the mixing comprises mixing nanoparticles including hollow silica nanoparticles, polytetrafluoroethylene (PTFE) nanoparticles, magnesium fluoride nanoparticles, calcium fluoride nanoparticles, silica nanoparticles or a combination thereof.

37. The method of claim 28, wherein mixing comprises mixing nanoparticle having an average diameter of about 5 nm to about 100 nm.

38. The method of claim 28, wherein the depositing comprises depositing the core ink having nanoparticles present in an amount of about 0.4% to about 2.2% by weight.

39. (canceled)

40. The method of claim 28, wherein depositing comprises depositing the plurality of cladding inks having about 5% to about 95% by weight of the nanoparticles proximal to the core ink.

41. (canceled)

42. The method of claim 28, wherein depositing comprises depositing the plurality of cladding inks having the nanoparticles in an amount of about 5% to about 95% by weight distal to the core ink.

43. (canceled)

44. The method of claim 25, further comprising:
forming a resin emulsion by mixing a resin with a solvent;
forming the core ink by mixing core nanoparticles with the resin emulsion; and
forming each of the plurality of cladding inks by mixing cladding nanoparticles with the resin emulsion, wherein the plurality of cladding inks have different concentrations of the nanoparticles.

45. The method of claim 44, wherein mixing comprises mixing the resin comprises mixing acrylic, urethane, or a combination thereof.

46.-51. (canceled)

52. The method of claim 44, wherein one or more of mixing the core nanoparticles and mixing the cladding nanoparticles comprises mixing tin oxide, alumina, zirconia, titania, or a combination thereof.

53. (canceled)

54. The method of claim 44, wherein mixing the core nanoparticles and mixing the cladding nanoparticles comprises mixing different nanoparticles.

55.-152. (canceled)
